(19) United States
(12) Patent Application Publication
(10) Pub. No.: US 2016/0242398 A1
(43) Pub. Date: Aug. 25, 2016

(54) System for attracting fish

(71) Applicant: Allan Richard Dampier, Courtenay (CA)

(72) Inventor: Allan Richard Dampier, Courtenay (CA)

(21) Appl. No.: 14/628,143

(22) Filed: Feb. 20, 2015

(51) Int. Cl. A01K 85/01; A01K 83/00; A01K 99/00; A01K 97/00

(52) U.S. Cl. CPC A01K 85/01; A01K 97/00; A01K 83/00; A01K 99/00

(57) ABSTRACT

A system for attracting fish by means of incorporating the metals of a lure, hook or fishing accessory along with anode metals to create a corrosion cell. The corrosion cell, also known as an electrochemical cell, when immersed in an electrolyte of fresh or salt water, will generate a fish attracting, positive (+) voltage field which radiates from the lure, hook or fishing accessory.

A system for attracting fish to a fishing lure, hook or fishing accessory may be achieved by creating a positive (+) voltage field of adequate strength that some fish species will be attracted to. A positive (+) voltage field may be generated by creating a corrosion cell, also known as an electrochemical cell. This cell will use the metals of a lure, hook or fishing accessory as the cathode. The metals of the lure, hook or fishing accessory must be of a high galvanic series rating, similar to stainless steel or nickel plated metals. An anode will be electrically connected to the opposite end of the lure, hook or accessory where fish capture is expected to occur. The anode will be made from metals that have a lower galvanic series rating, similar to aluminum, zinc and magnesium. The anode will typically be quite small in relation to the size of the cathode. Once electrical continuity is established between anode and cathode and the cell is immersed in an electrolyte of fresh or salt water, a positive (+) voltage field will radiate from the cathode portion of the cell. It is believed that electrical continuity is best, from the anode, through the lure body and including the hook(s) as that is where an angler wants a target fish to strike. The amount of voltage generated by the cell will be dependant upon: the amount of exposed metals of the anode and cathode, how much of the surface of the metals of the anode and cathode have electrical conductivity, the conductivity of the electrolyte and the galvanic series rating of the cathode and anode. Any exposed cathode metals that have a low rating on the galvanic series will cause a reduction in the level of the voltage field and should be replaced with metals that have a higher galvanic series rating.

### CROSS REFERENCE TO RELATED APPLICATIONS

USPTO provisional application No. 61/769,560 Date Feb. 26, 2013

USPTO provisional application No. 61/943,708 Date Feb. 24, 2014

### BACKGROUND OF THE INVENTION

Fishing is a popular commercial and recreational activity. It is well known in the prior art to use a variety of devices to improve a fisher's catch.

One approach that has been successful is the use of an electric field to attract target fish within a fishing zone.

In water, a boat hull having bonded metal components and sacrificial anodes will generate an electric field. Provided the metal downrigger wires are electrically connected to the boat's bonding system, the downrigger wires will develop a positive charge in the environment of the boat's electrical field. The positive charge is known to attract various species of fish.

It is known in the prior art to use a device commonly referred to as a “black box”, a device which may be used to measure and/or apply positive charge to the downrigger wires from the boat's electrical system to maintain the voltage in the wires within a desirable range to attract fish.

One disadvantage with use of a black box system is the location of the attracting charge. The charge attracts fish species to the downrigger wire, but not specifically to the lure or bait. It would be desirable to provide a fish attracting system which would attract fish species to the lure or bait where capture occurs.

REFERENCES CITED

| | | |
|---|---|---|
| U.S. Pat. No.: 5175950 | Linder | Apr. 9, 1992 |
| U.S. Pat. No.: 6457275 | Spurgeon | Nov. 2, 2000 |
| U.S. Pat. No.: 6807766 | Hughes | Dec. 3, 2001 |
| U.S. Pat. No.: 4,970,808 | Massie | Apr. 2, 1990 |

### OTHER REFERENCES

Canada Patent: 2360862

Canada: Patent: 2115227

Definition of Corrosion Cell (websites)

http://www.corrosionpedia.com/definition/1470/corrosion-cell

Corrosionpedia explains Corrosion Cell

A corrosion cell is a condition on a metal surface where flow of electric current occurs between two metal surfaces.

A corrosion cell consists of four fundamental components:
Anode
Cathode
Conducting environment for ionic movement (electrolyte)
Electrical connection between the anode and cathode for the flow of electron current

The driving force behind a corrosion cell is a potential or voltage difference between the anode and cathode. It is important to know that each of the four elements of the corrosion cell affect the severity of corrosion.

http://www.corrosionpedia.com/definition/740/local-corrosion-cell

Corrosionpedia explains Local Corrosion Cell

Local corrosion cells come in many forms. Some of the most common are:

Dissimilar metals: This corrosion cell is composed of two metals in a single phase that are in contact. Good examples are zinc, nickel, iron and gold. The metal that is higher in the electrochemical series will be classified as the cathode. The other will be the anode and will suffer corrosion. Dissimilar metals that are in contact, bathed in an appropriate electrolyte, is the principle behind batteries. In this type of reaction, controlled corrosion can be observed.

### BRIEF SUMMARY OF THE INVENTION

In prior art of attracting fish with the use of electric fields, the fields either originate from the metal downrigger trolling wires or possibly from lures or accessories that may be battery powered, use magnets, piezoelectric crystal or self contained electric generators. This invention simply uses the lure, hook or accessory metals, combined with sacrificial anode metals, to create a corrosion cell, also referred to as an electrochemical cell. In this type of cell, corrosion occurs at the anode. A by-product of corrosion is electricity. It is simply a matter of choosing the correct anode metals that match your lure, hook or fishing accessory metals according to the galvanic series, and matching this cell to the conductivity of the electrolyte, as in fresh or salt water, in order to generate the voltage that may be desirable to one's target species of fish.

### BRIEF DESCRIPTION OF THE DRAWINGS

A detailed description of the preferred embodiments is provided by way of example only and with reference to the following drawings, in which:

Drawing 1 depicts an embodiment of a fish attracting system for use with a metal fishing lure, in which a corrosion cell is formed between a cathodic metal hook attached to a metal lure and an anodic metal bead threaded on to the fishing line allowing for the bead to slide freely and to make electrical contact with the forward most metal portion of the lure. The contact between anode and cathode in this example, is maintained by water pressure of the forward motion of the lure, or intermittent contact if a jigging motion of the lure is implemented by the angler. The anode can also be electrically connected to the forward portion of the fishing lure as well, possibly with the use of fine, conductive wire.

Drawing 2 depicts an embodiment of a fish attracting system for use with a fishing lure, in which a corrosion cell is formed between a cathodic metal hook and an anodic metal bead contacting the metal portion of the hook.

Drawing 3 depicts a preferred embodiment of a fish attracting system for use with a fishing line, according to the invention, comprising an electric field generator connectable between a fishing rod and a fishing lure. The field generator is comprised of a cathode placed on the lure side and the anode is placed on the fishing rod side. This field generator, once electrical contact is created between anode and cathode, and submerged in an electrolyte of fresh or salt water, will create a positive (+) voltage field that will radiate and encompass the fishing lure.

Drawing 4 depicts a preferred embodiment of a fish attracting system for use on a downrigger setup where the field generator is attached to the downrigger line or wire, as well as to a fishing line release clip. The field generator radiates a positive (+) voltage field encompassing the fishing lure until such time that either a striking fish, or pulling motion of the fishing rod, will cause the release clip to become detached from the fishing line, allowing for the angler to attempt to capture the fish without the fishing line being connected in any manner to the downrigger setup.

Drawing 5 depicts a preferred embodiment of a fish attracting system for use on a non-conductive fishing lure where there is no electrical connection between the front metal tow post and the fishing hooks. In this scenario, a fine metal wire may be used to interconnect the metal tow post and the metal hook anchoring posts. An anodic bead is connected to the front tow post. Electrical continuity is now created between the anode and through to the hooks and a positive (+) voltage field will radiate from the hooks and connected tow post.

Drawing 6 depicts a preferred embodiment of a fish attracting system for use on a fishing lure, hook, fishing accessory or field generator.

FIG. 1 depicts an anode that is made in the shape of a C and is placed on a metal swivel between the barrel shaped body and the swivel eye. The anode is clamped closed in the shape of an O around the shank of the swivel eye in such as manner as to not fall off of the swivel, as well as to be electrically connected to the swivel.

FIG. 2 depicts an anode bead that has a center hole. The fishing line is passed through the anode and tied to a metal portion of a lure, hook or fishing accessory allowing for the anode to slide freely on the fishing line and to contact the metal of the lure, hook or fishing accessory and creating a corrosion cell.

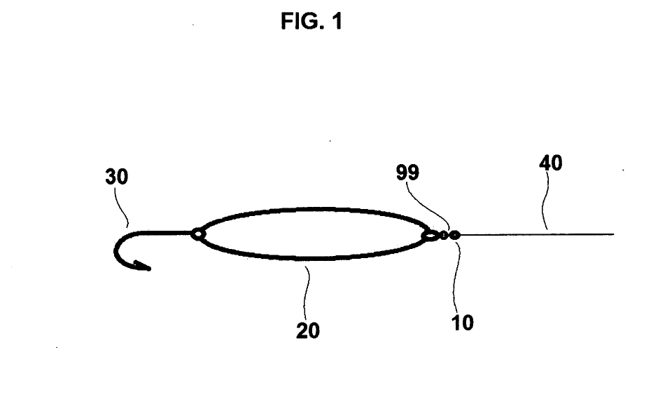

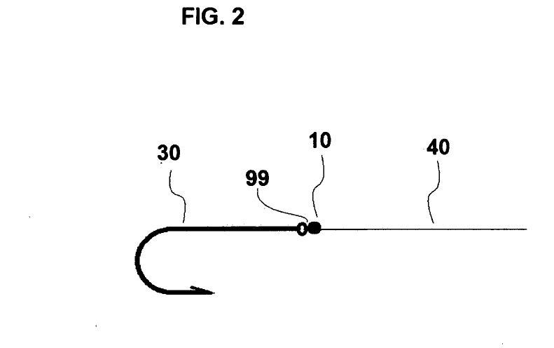

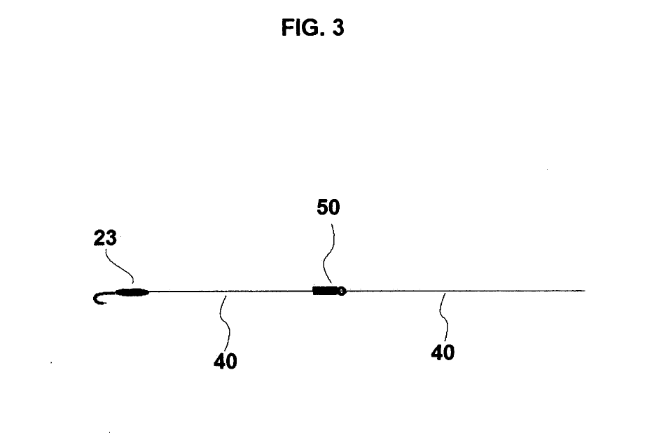

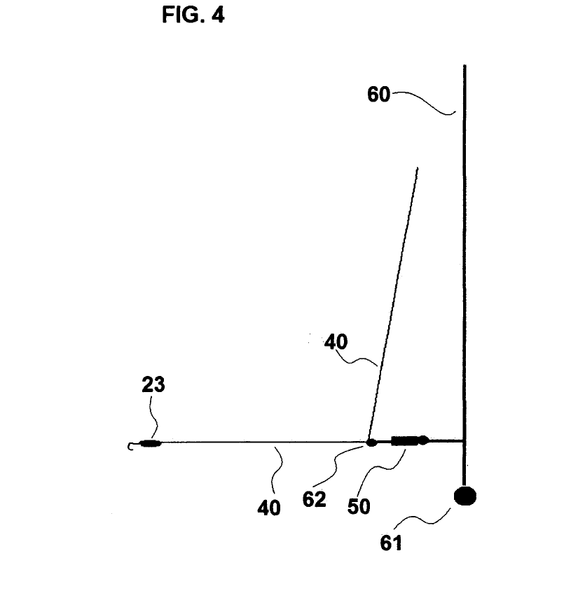

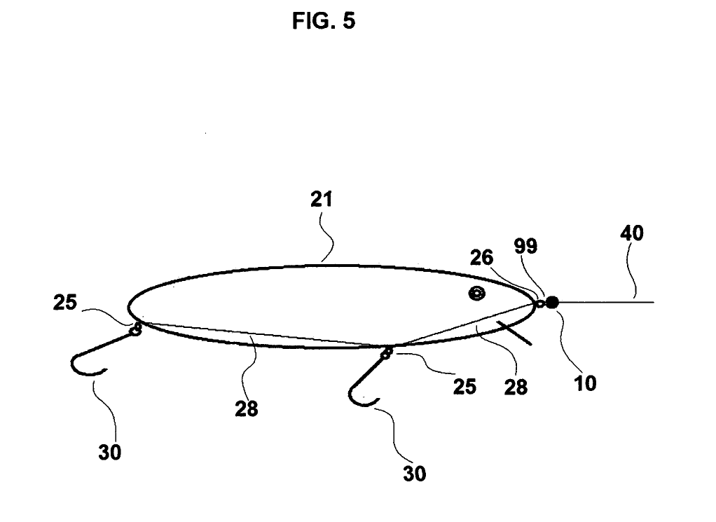

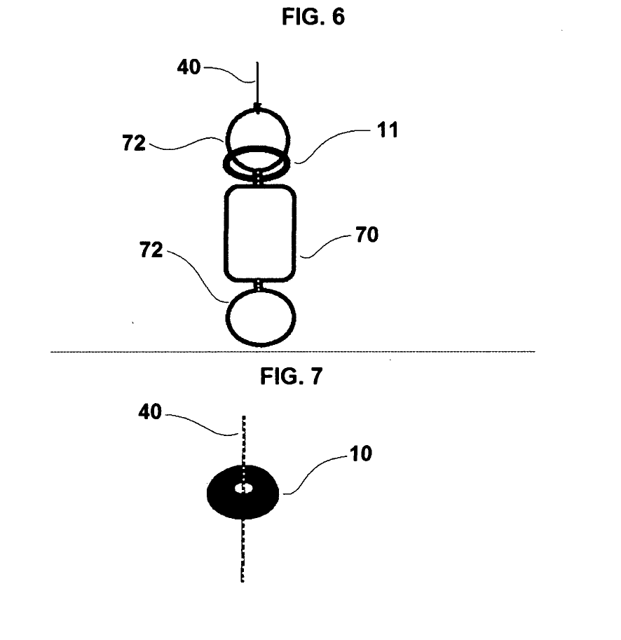

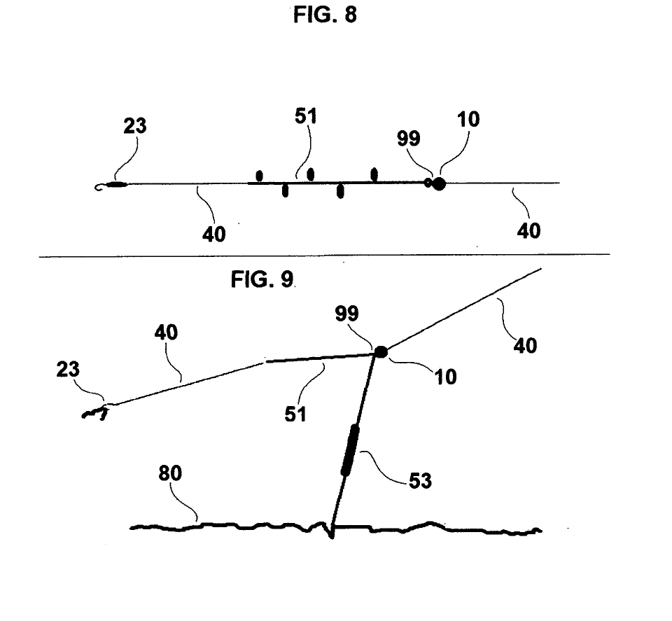

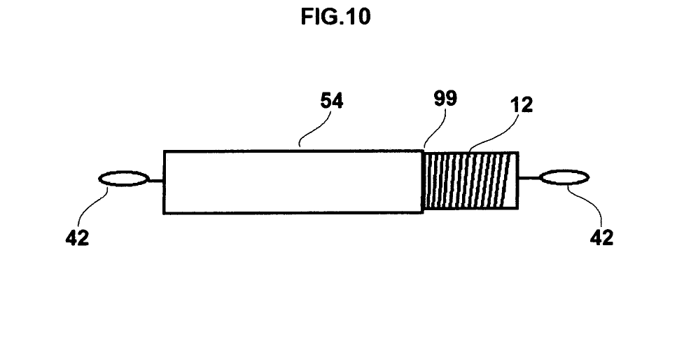

Drawing 7 depicts a preferred embodiment of a fish attracting system for use on a metal fishing accessory. In both FIG. 1 and FIG. 2, the accessories function in the same manner as an electric field generator and form a corrosion cell that radiates a positive (+) voltage field that encompasses the fishing lure.

FIG. 1 shows an anode contacting the forward-most metal portion of a lake troll that is attached to, and towing a fishing lure through the water.

FIG. 2 shows an anode contacting the forward-most metal portion of a bottom bouncer that is attached to and towing a fishing lure through the water.

Drawing 8 depicts a preferred embodiment of a fish attracting system for use on an electric field generator. In this instance, a stainless steel tube is attached to a galvanized or aluminum wire coil that is furthest away from where fish capture is expected to occur. The stainless steel tube is the cathode and the galvanized or aluminum wire is the anode. When placed in an electrolyte of fresh or salt water, a corrosion cell is created and a positive (+) voltage field will radiate from the cathode portion of the cell.

In the drawings, various embodiments of the invention are illustrated by way of example. It is to be expressly understood that the description and drawings are only for the purpose of illustration and as an aid to understanding, which are not intended as a definition of the limits of the invention.

### DETAILED DESCRIPTION OF THE INVENTION

There is provided a portable system for attracting fish for commercial or recreational fishing. Various fish species are responsive to an electrical field. At an appropriate voltage, understood in the prior art to be between 0.4 Volts and 1.0 Volts for many target species, an electrical field can serve as an attractant to fish. The present invention teaches a system for attracting fish to the vicinity of one or more cathodic metal hooks, lures or fishing accessories, to increase the likelihood that a fish will be caught.

The principle of the present invention is generation of an electric field on or near a fishing lure with the use of a corrosion cell. The corrosion cell is formed by the chemical reaction between two or more dissimilar metals electrically connected and immersed in an electrolyte of fresh or salt water, such as would be encountered in a fishing zone. The lure forms the cathode, and a separate metal compound forms the anode of the cell. For example the anode may be a zinc bead attached to a fishing line in proximity to the lure, and electrically connected to a metal component of the lure, hook or accessory. The amount of positive voltage created at the cathode is dependant on many factors including the galvanic rating and size of the metal components used, the amount of exposed metal of the cathode and anode as well as the conductivity of the water in which fishing is to occur.

Various fish species are understood to be attracted to positive (+) voltages. Preferably ranging between 0.4 and 1.0 volts. However, as these values are based on voltages measured at a trolling wire, a different range of voltages may be desirable when the electrical field is generated at the lure. Experimental results indicate that a voltage of approximately 0.6 volts may be achieved in fresh water using a cathode made of stainless steel and an anode made of zinc or aluminum. Further experimentation will determine the ideal voltage ranges for each application of the present invention.

As shown in diagram 1, the present invention comprises the selective placement of small amounts of anode metal attached to the fishing lures. The metal may be in the form of small beads, but a wide range of shapes and sizes of base metals are possible. For example, in a preferred embodiment, the metal may be zinc, aluminum or magnesium beads or wire loops. The distance between the cathode and the anode may vary by adjusting the position of the anode along the fishing line when fine conductive wire is used to join the anode to the cathode.

The fish attracting system of the present invention may be used in a wide variety of fishing applications, including casting, still fishing, trolling and fly fishing. Use of the present invention over time will reduce the effectiveness of the system for attracting fish as corrosion will build up around the anode and reduce the level of the voltage. As such, it is desirable to periodically clean the anode in order to maintain the desired positive charge at the lure, hook or fishing accessory.

Experimental results using a 30 foot insulated trough with fresh water demonstrated generation of a measurable electric field 30 feet away from an electric field generator or voltage tuned fishing lure comprised of two dissimilar metals and connected together within the trough.

A downrigger electric field generator may be used with a downrigger line system. As shown in diagram 4, the field generator may be connected between the downrigger and the fishing line underwater. An electric field generator may also be used without a downrigger as shown in diagram 3. According to one embodiment, the downrigger electric field generator may comprise a metal tube as cathode and a coiled wire as anode, as shown in diagram 8. Other embodiments of the field generator having other forms of cathode and anode are also possible and are within the scope of the invention. The electric field generator may attract fish species into the general vicinity of the lure or bait. A fisher may use an electric field generator together with a voltage tuned lure or hook.

An electrical field may also be created in proximity to the lure by connecting anodes to metal portions of fishing accessories such as flashers, attractors, wire leaders, lake trolls, bottom bouncers and other fishing accessories as examples show in diagram 7, FIGS. 1 & 2.

According to another embodiment of the invention, fishers using conductive stainless steel downrigger wire may use an electric field generator to boost a positive electrical field generated on the downrigger wire. If a fisher is using non-conductive downrigger line, an electric field generator may be used to create a positive field. This will provide fish attraction to the vicinity of the downrigger wire or line, and lure.

According to a further embodiment of the invention, lures with non-conductive bodies may be voltage tuned from front to back by electrically connecting the metal portions of the lure with the use of fine conductive wire and attaching an anode to the front of the lure metal, as shown in diagram 5. This will complete the circuit from anode to hooks and a voltage field will be created.

It is common in using downrigger wires and lines to use downrigger weights. As the lead in such weights may be contaminated with various metals and causing unwanted electric fields, the lead should be insulated from the system and the weights should be coated with a non-conductive material.

A key feature of the present invention is it's portability. In contrast with prior art black box systems which use a boat hull as anode, the present invention includes anode and cathode in a compact, portable device which may be transferred easily between vessels.

From the foregoing, it will be seen that this invention is one well adapted to attain all of the ends and objectives herein set forth, together with advantages which are obvious and which are inherent to the apparatus. This is contemplated by and is within the scope of the claims. As many possible embodiments may be made of the invention without departing from the scope of the claims. It is to be understood that all matter herein set forth or shown in the accompanying drawings is to be interpreted as illustrative and not in a limiting sense. It will be appreciated by those skilled in the art that other variations of the preferred embodiment may also be practised without departing from the scope of the invention.

I claim:

1. A fishing lure, hook or fishing accessory: will become part of a corrosion cell and be voltage tuned so that fish that are receptive to positive voltage fields will be attracted to the vicinity of the originating voltage field and to strike at the lure present.

2. A fishing lure, hook or fishing accessory of claim 1:
Will be made of, or have exposed metal components that are high on the galvanic series, like stainless steel or nickel plated metals that will become the cathode and positive (+) portion of a corrosion cell.
An anode that is quite low on the galvanic series, like zinc, aluminum or magnesium, will be electrically connected to the cathode of the lure, hook or fishing accessory, preferably at a point furthest away from where fish capture is expected to occur.
The anode, once electrical continuity is established between the cathode and anode, will become the negative (−) portion of the corrosion cell.
Once immersed in an electrolyte of salt or fresh water, the corrosion cell will be activated, resulting in a positive (+), fish attracting voltage radiating from the cathode portion of the corrosion cell.
The positive (+) voltage potential range achievable with this type of corrosion cell is from 0.0 volt up to over 1.5 volts depending on an angler's requirements.

3. A fishing lure, hook or fishing accessory of claim 1: may have an anode that is attached to the cathode in such a manner as to have intermittent contact with the cathode, resulting in an intermittent voltage field being created which may be more appealing to target fish species.

4. A fishing accessory in claim 1: will include, but will not be limited to, items commonly known by anglers as: flashers, attractors, bottom bouncers, wire leaders, spreaders, lake trolls, spinners and electric field generators, as displayed in drawings 3, 4 and 8.

5. Many combinations of anode and cathode metals, including multiple metals with varying galvanic ratings may be used to achieve the desired level of the positive (+) voltage field.
